(19) United States
(12) Patent Application Publication
(10) Pub. No.: US 2015/0332653 A1
(43) Pub. Date: Nov. 19, 2015

(54) IMAGE PROCESSING APPARATUS, IMAGE PROCESSING SYSTEM, AND IMAGE PROCESSING METHOD

(71) Applicant: Akihiro KAKINUMA, (US)

(72) Inventor: Akihiro KAKINUMA, Kanagawa (JP)

(21) Appl. No.: 14/652,906

(22) PCT Filed: Feb. 4, 2014
(86) PCT No.: PCT/JP2014/052982

§ 371 Date: Jun. 17, 2015

(30) Foreign Application Priority Data
Mar. 5, 2013 (JP) 2013-042608

(51) Int. Cl. G09G 5/02; H04N 1/46; G06K 9/46

(52) U.S. Cl. CPC G09G 5/028; G06K 9/4652; H04N 1/465; G09G 2300/0452; G09G 2320/0242

(57) ABSTRACT

An image processing apparatus includes a region extraction unit that extracts a conversion region from input image data; a color information acquisition unit that acquires color information from the conversion region; a target color information acquisition unit that acquires target color information, which is a target of conversion for the color information; a conversion unit that generates conversion information based on the color information and the target color information, and converts the color information based on the conversion information, to generate converted image data; a display and input unit that displays the input image data and the converted image data, and receives an input of a final conversion target, which is a final target of conversion for the color in formation; and a final conversion unit that generates final conversion information based on the final conversion target, and converts the color information based on the final conversion information, to generate final image data.

### TECHNICAL FIELD

The present invention relates to an image processing apparatus, image processing system and image processing method.

### BACKGROUND ART

Image data, captured by, for example, a digital camera or image data read by a scanner or the like, are used in various forms, such as an output on a recording paper or the like from various types of printers, a display on a monitor screen or the like.

Image characteristics of such image data, in many cases, may be different, even for a similar object or a similar image scene, according to differences in characteristics of the digital camera or the scanner, or differences in output targets of respective manufacturers. The image data do not always reproduce a color tone or a gray level such as to satisfy a user.

Accordingly, the user needs to modify the image data in order to obtain the desired image. There are a wide variety of methods of modifying image data depending on, especially for commercial use, a purpose of use or a target (destination of distribution), and work load may increase with the number of image data to be modified.

The user has to adjust a large number of parameters, such as contrast, color phase or color balance when modifying image data. Such an adjustment process requires a high level of knowledge, technology, experience, or the like, and it may be hard to obtain the desired image.

Regarding the above problem, Patent Document 1 discloses an image processing method, which displays plural target images having different color tones, prompts a user to select the target image having a desired color tone, and changes the color tone within a specified region of image data to the color tone of the selected target image. According to the method disclosed in Patent Document 1, the user doesn't need to control the complicated image parameters, and can obtain the desired image with a simple operation.

### CITATION LIST

### Patent Literature

Patent Document 1: Japanese Published Patent Application No. 2001-251531.

### DISCLOSURE OF INVENTION

### Problem to be Solved by the Invention

However, in the image processing method disclosed in Patent Document 1, although the color tone of the image can be modified to have a color tone previously provided of the target image, the image cannot be modified to have a color tone with a characteristic other than the color tones in the target image. That is, it is difficult to modify the image data of the target images to have an expression or a feature of not the previously prepared color tones but a color tone located between them.

For example, for image data, such as human skin, in which a small change in color reproduction or gradation significantly affects the expression, a method of modification with a simple operation, which can deal flexibly with a small and continuous change in the image expression is desired.

In view of the above subject matter, it is a general object of at least one embodiment of the present invention to provide an image processing apparatus, by which a user can modify image data with a simple operation to have a desired color tone.

### Means to Solve the Problems

In order to solve the above problem, according to an aspect of the present invention, an image, processing apparatus includes a region extraction unit that extracts a conversion region from input image data; a color information acquisition unit that acquires color information from the conversion region; a target color information acquisition unit that acquires target color information, which is a target of conversion for the color information; a conversion unit that generates conversion information based on the color information and the target color information, and converts the color information based on the conversion information, to generate converted image data; a display and input unit that displays the input image data and the converted image data, and receives an input of a final conversion target, which is a final target of conversion for the color information; and a final conversion unit that generates final conversion information based on the final conversion target, and converts the color information based on the final conversion information, to generate final image data.

According to another aspect of the present invention, an image processing system includes an image processing apparatus and an information processing terminal, which are connected with each other via a network. The image processing apparatus includes a region extraction unit that extracts a conversion region from input image data; a color information acquisition unit that acquires color information from the conversion region; a target color information acquisition unit that acquires target color information, which is a target of conversion for the color information; a conversion unit that generates conversion information based on the color information and the target color information, and converts the color information based on the conversion information, to generate converted image data; and a final conversion unit that generates final conversion information based on an input final conversion target, which is a final target of conversion for the color information, and converts the color information based on the final conversion information, to generate final image data. The information processing terminal includes a display and input unit that displays the input image data and the converted image data, and receives an input of the final conversion target.

According to yet another aspect of the present invention, an image processing method includes a region extraction step of extracting a conversion region from input image data; a color information acquisition step of acquiring color information from the conversion region; a target color information acquisition step of acquiring target color information, which is a target of conversion for the color information; a conversion step of generating conversion information based on the color information and the target color information, and converting the color information based on the conversion information, to generate converted image data; a display input step of displaying the input image data and the converted image data, and receiving an input of a final conversion target, which is a final target of conversion for the color information; and a final conversion step of generating final conversion information based on the final conversion target, and converting the color information based on the final conversion information, to generate final image data.

### Effects of the Present Invention

According to the present invention, an image processing apparatus, by which a user can modify image data with a simple operation to have a desired color tone, is provided.

### BRIEF DESCRIPTION OF DRAWINGS

FIG. 1 is a diagram illustrating an example of a hardware configuration of an image processing apparatus according to a first embodiment;

FIG. 2 is a diagram illustrating an example of a functional configuration of the image processing apparatus according to the first embodiment;

FIGS. 3A and 3B are diagrams illustrating an example of input image data and a conversion region according to the first embodiment;

FIGS. 4A and 4B are diagrams illustrating an example of color information according to the first embodiment;

FIG. 5 is a diagram illustrating an example of display of input image data and target image data according to the first embodiment;

FIGS. 6A to 6C are diagrams illustrating an example of a conversion table of the color information according to the first embodiment;

FIG. 7 is a diagram illustrating an example of display of input image data, converted image data and final image data according to the first embodiment;

FIGS. 8A to 8C are diagrams illustrating examples of input of a final conversion target according to the first embodiment;

FIGS. 9A to 9C are diagrams illustrating examples of generation of final target color information according to the first embodiment;

FIGS. 10A and 10B are diagrams illustrating examples of weight coefficients according to the first embodiment;

FIG. 11 is a diagram illustrating an example of generation of final conversion data according to the first embodiment;

FIG. 12 is a flowchart illustrating an example of a process of image processing according to the first embodiment;

FIG. 13 is a flowchart illustrating an example of a process of acquiring the target color information according to the first embodiment;

FIG. 14 is a flowchart illustrating an example of a process of generating a final image according to the first embodiment;

FIG. 15 is a flowchart illustrating an example of a process of generating the final image according to the first embodiment;

FIG. 16 is a diagram illustrating an example of a configuration of an image processing system according to a second embodiment;

FIG. 17 is a diagram illustrating an example of a hardware configuration of an image processing apparatus according to the second embodiment;

FIG. 18 is a diagram illustrating an example of a hardware configuration of an image processing server according to the second embodiment; and

FIG. 19 is a diagram illustrating an example of a functional configuration of the image processing system according to the second embodiment.

### BEST MODE FOR CARRYING OUT THE INVENTION

Although the present invention has been described with reference to embodiments, the present invention is not limited to these embodiments, but various variations and modifications may be made without departing from the scope of the invention as set forth in the accompanying claims.

In the following, embodiments of the present invention will be described with reference to the accompanying drawings. Meanwhile, the same reference numerals are assigned to the members which have substantially the same functions or configuration, and duplicate explanations are omitted.

### First Embodiment

<Hardware Configuration of Image Processing Apparatus>

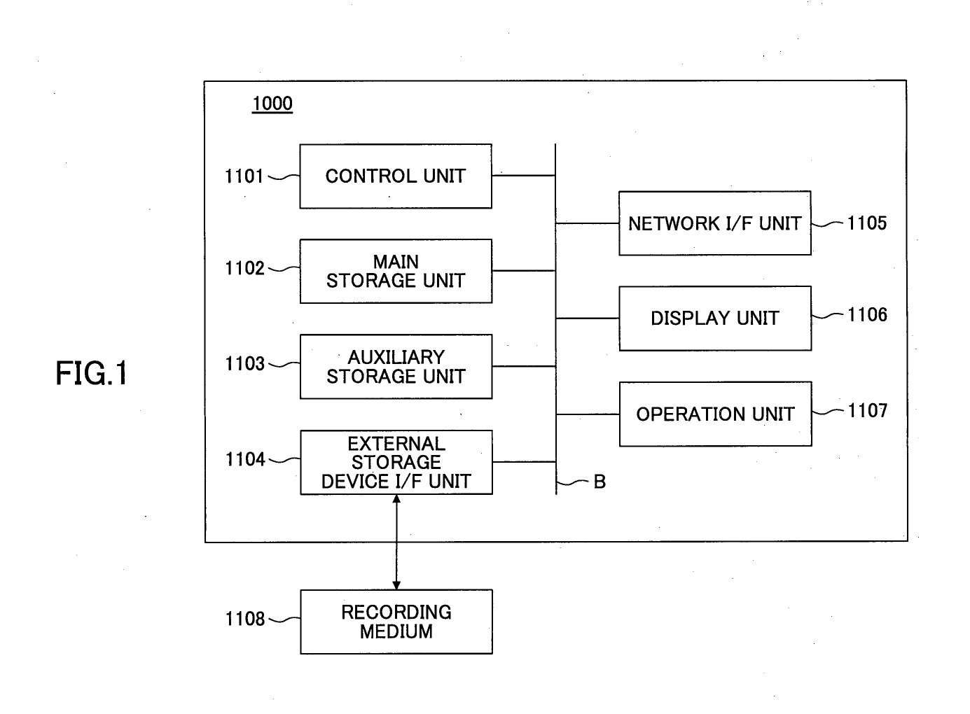

FIG. 1 illustrates a hardware configuration of an image processing apparatus according to the first embodiment.

As shown in FIG. 1, the image processing apparatus 1000 includes, a control unit 1101, a main storage unit 1102, an auxiliary storage unit 1103, an external storage device I/F unit 1104, a network I/F unit 1105, a display unit 1106 and an operation unit 1107, which are connected with each other via a bus B.

The control unit 1101 is a CPU (Central Processing Unit), which controls each unit and performs calculation and processing for data in a computer. Moreover, the control unit 1101 is a processor that executes a program stored in the main storage unit 1102 or the auxiliary storage unit. The control unit receives data from an input unit or a storage unit, calculates and processes the data, and outputs the data to an output unit or the storage unit.

The main storage unit 1102 is, for example, a ROM (Read-Only Memory), a RAM (Random Access Memory), or the like. The main storage unit 1102 stores or temporarily saves a program, such as an operating system (OS) as a basic system or application software executed at the control unit 1101, or data.

The auxiliary storage unit 1103 is, for example, a HDD (Hard Disk Drive), or the like. The auxiliary storage unit 1103 stores data related to the application software or the like.

The external storage device I/F unit 1104 is an interface between a recording medium 1108, such as a flash memory, connected via a data transmission path, such as a USB (Universal Serial Bus) and the image processing apparatus 1000.

The program stored in the recording medium 1108 is installed via the external storage device I/F unit 1104, and becomes executable by the image processing apparatus 1000.

The network I/F unit 1105 is an interface between a peripheral device having a communication device connected via a network such as a LAN (Local. Area Network) or a WAN (Wide Area Network), which are configured by a data communication path of a wireless and/or a wired line and the image processing apparatus 1000.

The display unit 1106 is, for example, a display device of a liquid crystal, an organic EL (Electro Luminescence), or the like. The display unit 1106 displays an image and an operation icon, and is a user interface which performs various settings when the user uses functions, which the image processing apparatus 1000 is equipped with.

The operation unit 1107 is, for example, a key switch including a hardware key or a mouse. Moreover, the operation unit 1107 may be a touch panel, provided overlapping with the display unit 1106.

<Functional Configuration of Image Process Apparatus>

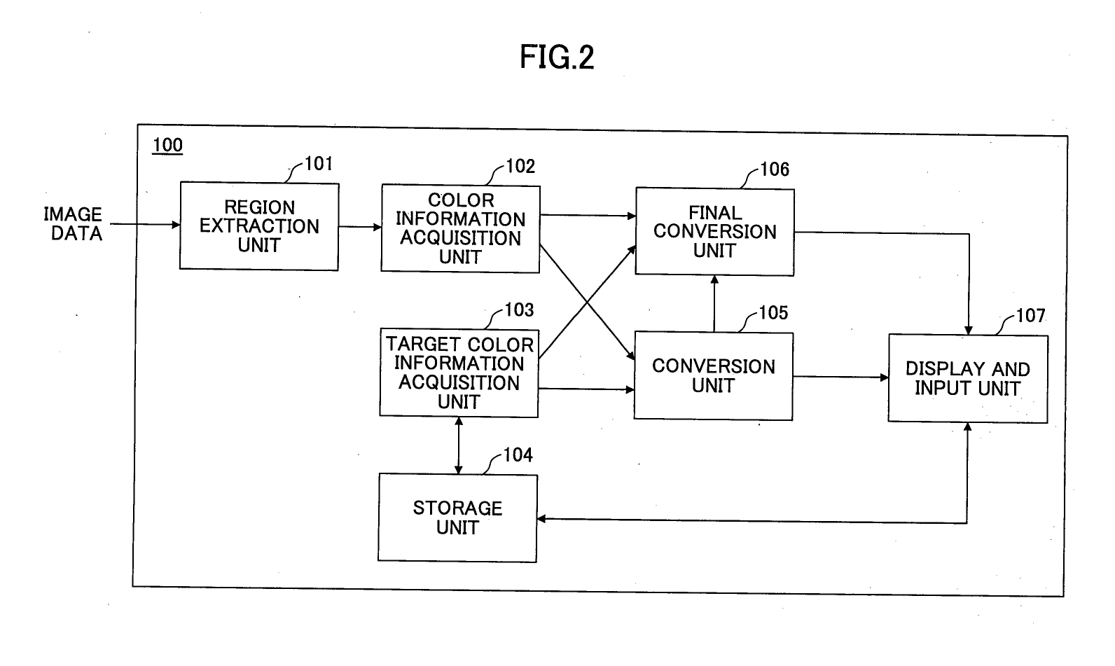

FIG. 2 illustrates a functional configuration of the image processing apparatus 100 according to the first embodiment.

As shown in FIG. 2, the image processing apparatus 100 according to the first exemplary embodiment includes a region extraction unit 101, a color information acquisition unit 102, a target color information acquisition unit 103, a storage unit 104, a conversion unit 105, a final conversion unit 106, and a display and input unit 107.

The region extraction unit 101, the color information acquisition unit 102, the target color information acquisition unit 103, the conversion unit 105, and the final conversion unit 106 are functions realized by executing a program stored in the main storage unit 1102 by the control unit 1101. The storage unit 104 is the main storage unit 1102 and the auxiliary storage unit 1103. The display and input unit 107 is realized by controlling the display unit 1106 and the operation unit 1107 by the control unit 1101.

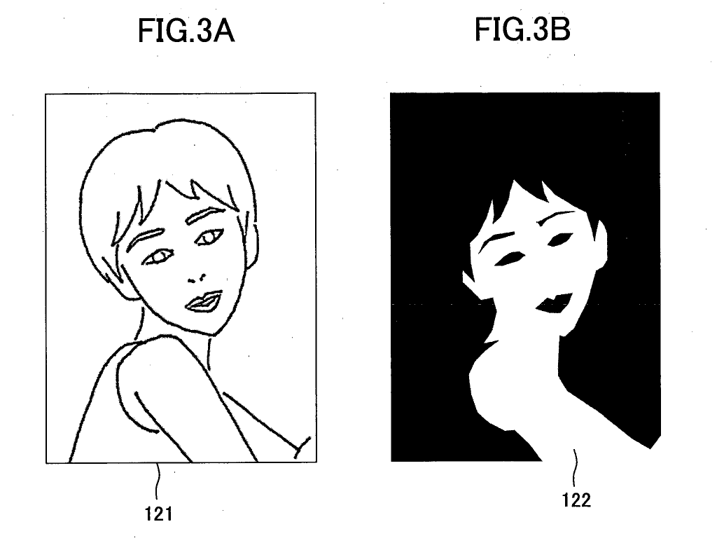

In the following, contents of a process of the respective units, which performs a conversion of a color tone within a selected region of image data input to the image processing apparatus, will be described in conjunction with data used for the image processing as shown in FIGS. 3 to 11.

<<Extraction of Region>>

To the image processing apparatus 100, image data including one or plural regions which are objects of the image processing are input. The region extraction unit 101 extracts a conversion region, where the color information is to be converted. The conversion region is a region selected from the input image data by a user who executes the image processing, at the display and input unit 107. The conversion region is, for example, a region of the skin, the sky, the green of plants and trees, or the like in the image data. In the following, a selection of human skin as the conversion region will be exemplified. The conversion region may be a region different from the skin region.

FIGS. 3A and 3B illustrate an example of an input image data 121 input to the image processing apparatus 100, and an extraction of the conversion region 122 by the region extraction unit 101. FIG. 3A illustrates the input image data 121, and FIG. 3B illustrates the conversion region 122 (white region) extracted from the input image data 121.

FIG. 3B shows a clear dividing line between the conversion region 122 (white region) and the region other than the conversion region 122 (black region). However, the border between the conversion region 122 and the region other than the conversion region may be blurred. Furthermore, the degree of blurring may be changed at different positions.

<<Color Information Acquisition>>

The conversion region 122 is extracted from the input image data 121 by the region extraction unit 101, as above. Next, the color information acquisition unit 102 acquires color information of pixels included in the conversion region 122.

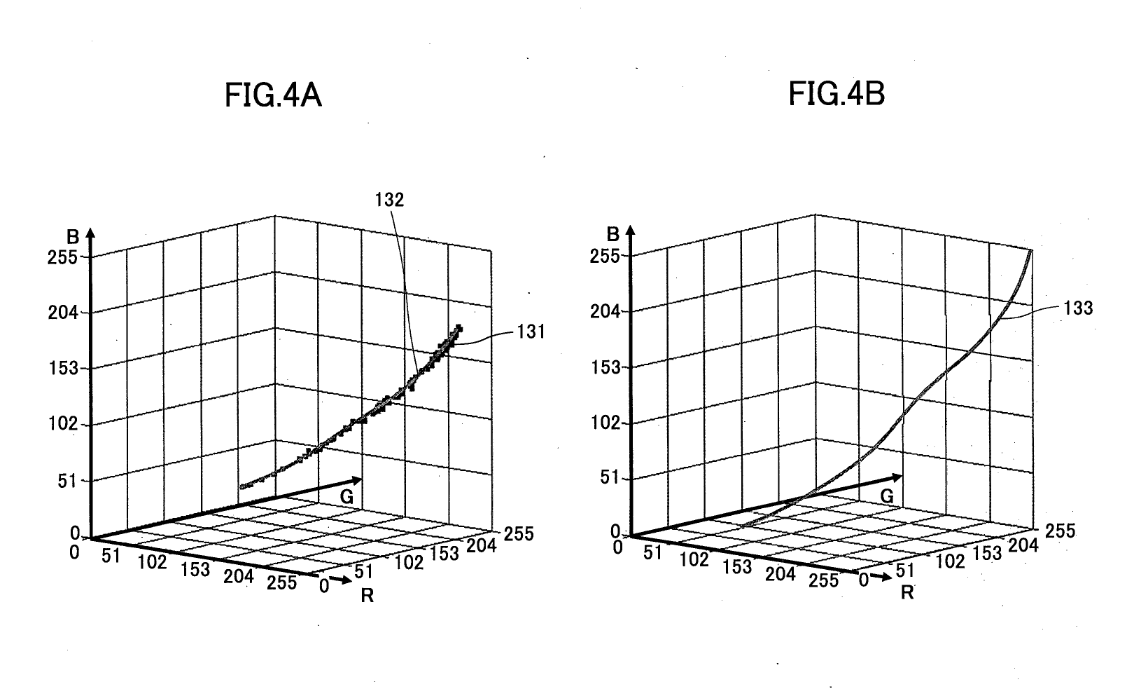

FIG. 4A illustrates the color information acquired by the color information acquisition unit 102. In FIG. 4A, color components 131 of the pixels included in the conversion region 122, acquired as eight bits tone values of RGB (0 to 255) by the color information acquisition unit 102, are plotted in a three-dimensional graph.

The image processing apparatus 100 according to the first embodiment uses the 8 bits tone values of RGB as the color components 131 of the pixels included in the conversion region 122. But various color components may be used according to the purpose of use of the processed image, and to the environment of the image processing.

For example, when the image data includes the four color versions of CMYK (Cyan, Magenta, Yellow Black), as used for offset orienting or letterpress printing, a halftone ratio (%) of CMYK as the color components is used. However, in order to express four components, at least two data sets are required, including, for example, a three-dimensional plot by three attributes of C, M and Y, and a two-dimensional plot for the remaining K, as a combination of M and K.

Moreover, as the color components, the L*a*b* color system, which is a representative of a color matching function, may be used. In this case, as the color components to be acquired, three attributes of L* (brightness), a* (degree of red to green), and b* (degree of yellow to blue), or three attributes of L* (brightness), c* (chroma) and h* (Hue) may be used. Furthermore, as the color components, not limited to the above example, but various color spaces, such as an HSV space or a YCbCr space, may be used.

The color information acquisition unit 102 preferably acquires color components 131 of all pixels included in the conversion region 122. However, the color information acquisition unit 102 may draw a sample from the pixels included in the conversion region 122 and acquire color components 131 of the sampled pixels.

By drawing a sample from the pixels and acquiring the color components 131, the problem in the case of large image data size where the data to be acquired becomes large and the processing speed decreases, can be avoided. However, in this case, pixels are preferably sampled, which include the pixel with the highest brightness point (or the minimum G tone point) and the pixel with the lowest minimum brightness point (or the maximum G tone point). Moreover, the pixels, from which color components are acquired, are preferably sampled unbiasedly, so that the acquired color components 131 can be expressed smoothly between the maximum brightness point (or the minimum G tone point) and the minimum brightness point (or the maximum G tone point).

The color information acquisition unit 102 acquires the color components 131 of the pixels included in the conversion region 122, as above. Next, the color information acquisition unit 102 calculates a three-dimensional tone function 132 from the color components 131, which quantitatively represent color tones as the color information of the conversion region 122.

In the three-dimensional graph illustrated by FIG. 4A, a solid curve along with the plotted color components 131 is the tone function 132 as color information calculated from the color components by the color information acquisition unit 102. The tone function 132 is, for example, an approximation function, obtained so that distances to data groups of the color components 131 of plural acquired pixels are minimum, by using a regression analysis.

The effective range of the tone function 132 is a range of brightness (or G tone value) between the maximum brightness (or the minimum G tone value) and the minimum brightness (or the maximum a tone value) of the color component 131 acquired by the conversion region.

<<Acquire Target Color Information>>

The color information acquisition unit 102 acquires the tone function 132 as the color information of the conversion region 122, as above. Next, the target color information acquisition unit 103 acquires target color information, the number of which is greater than or equal to one. The acquired target color information is close to the color tone of the conversion region 122, desired by the user who executes the image processing. The target color information may not coincide with a color reproduction target, which is the user's final aim.

FIG. 4B illustrates an example of a target tone function 133 as target color information acquired by the target color information acquisition unit 103. The target tone function 133 is assumed to have the same data format as the tone function 132, which represents the color information of the conversion region 122 acquired by the color information acquisition unit 102.

When image data are input into the image processing apparatus 100 and the user, who executes the image processing, selects a conversion region 122, for example, along with the input image data 121, a list of plural target image data, stored in the storage unit 104, is displayed on the display and input unit 107. The target color information acquisition unit 103 acquires the target tone function 133 of the target image data selected by the user who executes the image processing from the storage unit 104.

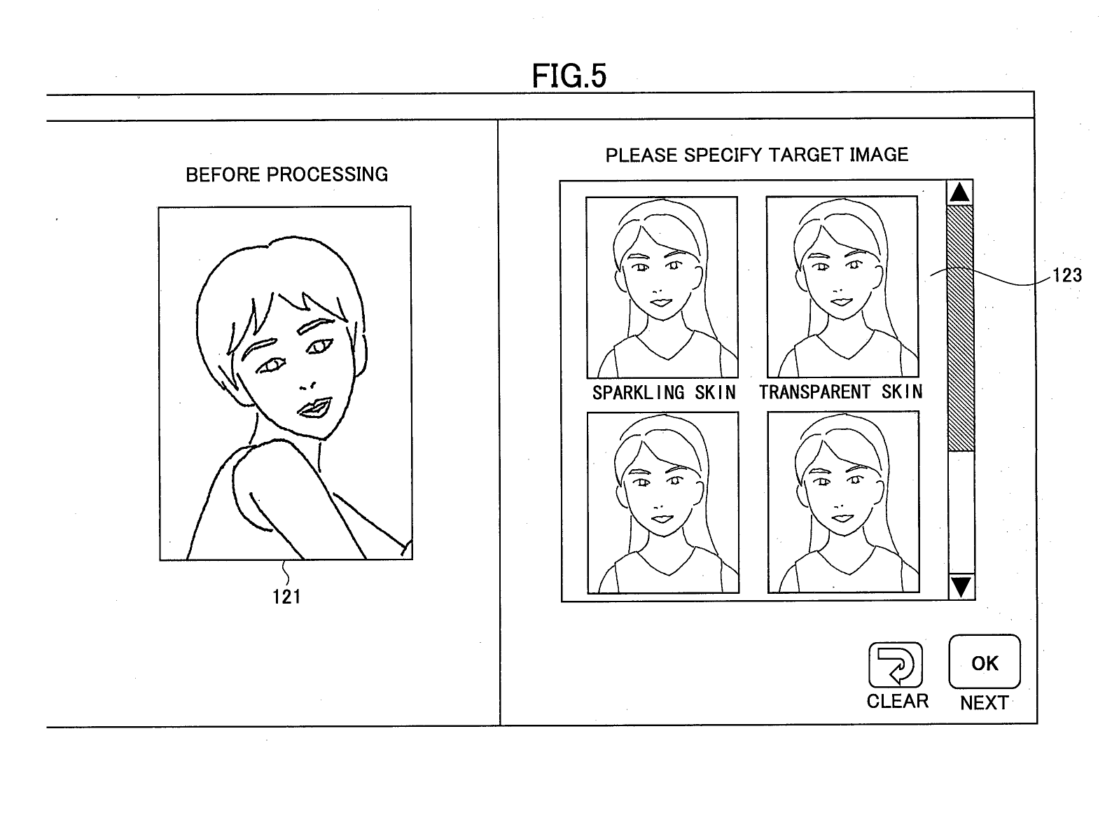

FIG. 5 is a diagram illustrating an example of the input image data 121 and the target image data group 123 on the display and input unit 107.

The storage unit 104 stores image data including a part which is often used as an object of image processing, such as human skin, the sky, or the green of plants and trees, as a target image data group 123 expressed by plural color tones. When the user executes the image processing, the conversion region 122 is selected from the input image data 121, and the display and input unit 107 acquires plural target image data groups 123 related to the conversion region 122 from the storage unit 104, and displays the acquired target image data groups.

When “human skin” is extracted as the conversion region 122, for example, a keyword, which represents a feature of each of the images in the target image data group 123, such as “sparkling”, “transparent”, “healthy” or the like, may be attached to the target image data group 123.

The user, who executes the image processing, selects one or more images, which is close to the desired color tone, from the plural images in the target image data group 123, displayed on the display and input unit 107. If the user's aim is to obtain a hard copy of the input image data 121 by using a printer or the like, the user may print the target image data group 123 with the printer, and select the target image data by viewing the printed target image data.

When the user who executes the image processing selects one or more image data from the target image data group 123, the target color information acquisition unit 103 acquires a target tone function 133 corresponding to the selected target image data, stored in the storage unit 104 as the target color information.

<<Converted Image Data Generation>>

When the color information acquisition unit 102 calculates the tone function 132 in the conversion region 122 of the input image data 121, and the target color information acquisition unit 103 acquires the target tone function 133, the conversion unit 105 converts the color tone of the conversion region 122.

The conversion unit 105, at first, generates a conversion table, as conversion data used for the color tone conversion in the conversion region 122 of the input image data 121.

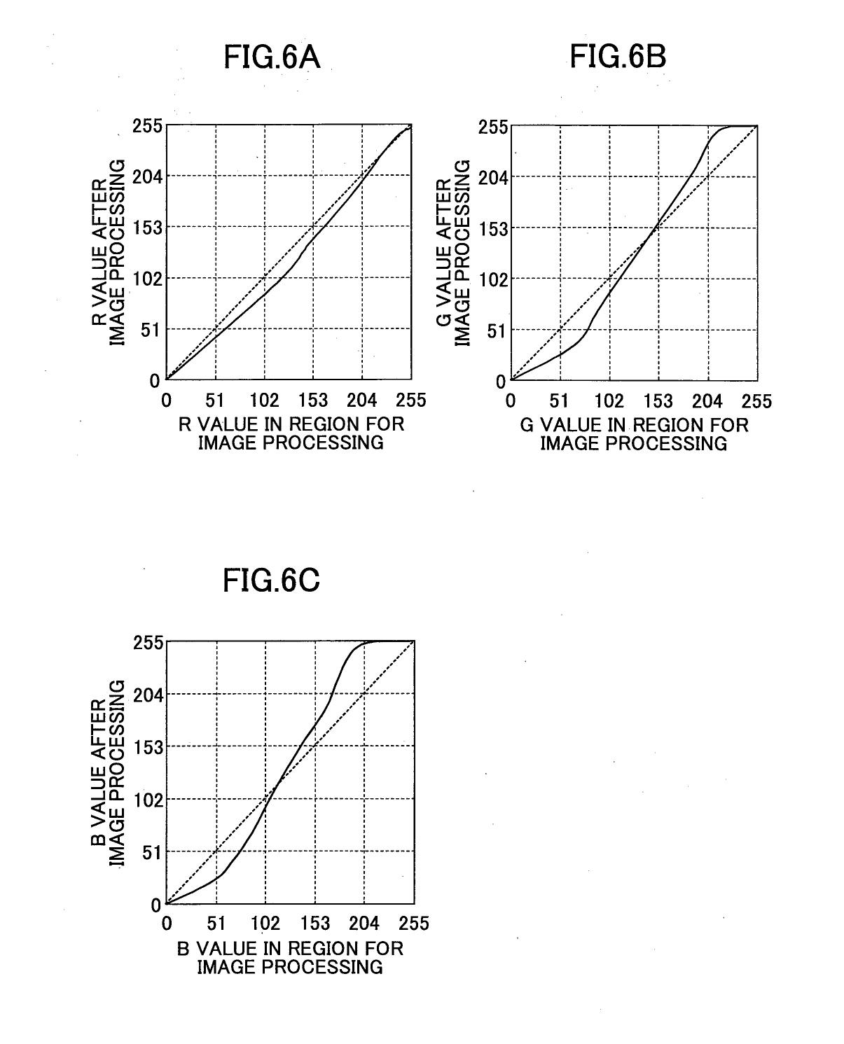

FIGS. 6A to 6C are diagrams illustrating an example of a conversion table, required from the tone function 132 corresponding to the conversion region 122 of the input image data 121 and from the target tone function 133 of the target image data. FIGS. 6A, 6B and 6C illustrate the conversion table of the R tone value, the conversion table of the G tone value and the conversion table of the B tone value, respectively. In each figure, the abscissa represents the tone value of the pixel in the conversion region 122, and the ordinate represents the tone value of the pixel after the conversion.

The conversion unit 105 generates a conversion table as conversion information, which linearly converts the tone function 132 of the conversion region 122 to the target tone function 133. The conversion table converts the color component values of the maximum brightness point and of the minimum brightness point in the tone function 132 to color component values of the maximum brightness point and of the minimum brightness point in the target tone value, respectively. The color component values between them are obtained by linear interpolation, so as to correspond to the target tone function 133 by a one to one relation. The conversion information is not limited to the conversion table, as described above. For example, the tone function 132 may be converted into the target tone function 133 according to a predetermined conversion relation.

When the conversion unit 105 generates the conversion table as the conversion information, the conversion unit 105 performs RGB tone conversion of all the pixels in the conversion region 122 of the input image data 121, using the conversion table. The conversion unit 105, according to the above process, generates converted image data, in which a color tone in the conversion region 122 is converted to a color tone expressed by the target tone function 133 of the selected target image data. The conversion unit 105 may perform the color tone conversion for pixels in a region other than the conversion region 122 in the same way, so that the color tone of the whole input image data 121 is converted.

In the case that the user, who executes the image processing, selects plural target image data, the conversion unit 105 obtains conversion information for each of the selected target image data, performs the color tone conversion for the input image data 121, and generates plural converted image data.

In the following, the target image data “A” and the target image data “B” are selected, the conversion unit 105 generates converted image data “A” and the converted image data “B”.

<<Image Display and Input Reception>>

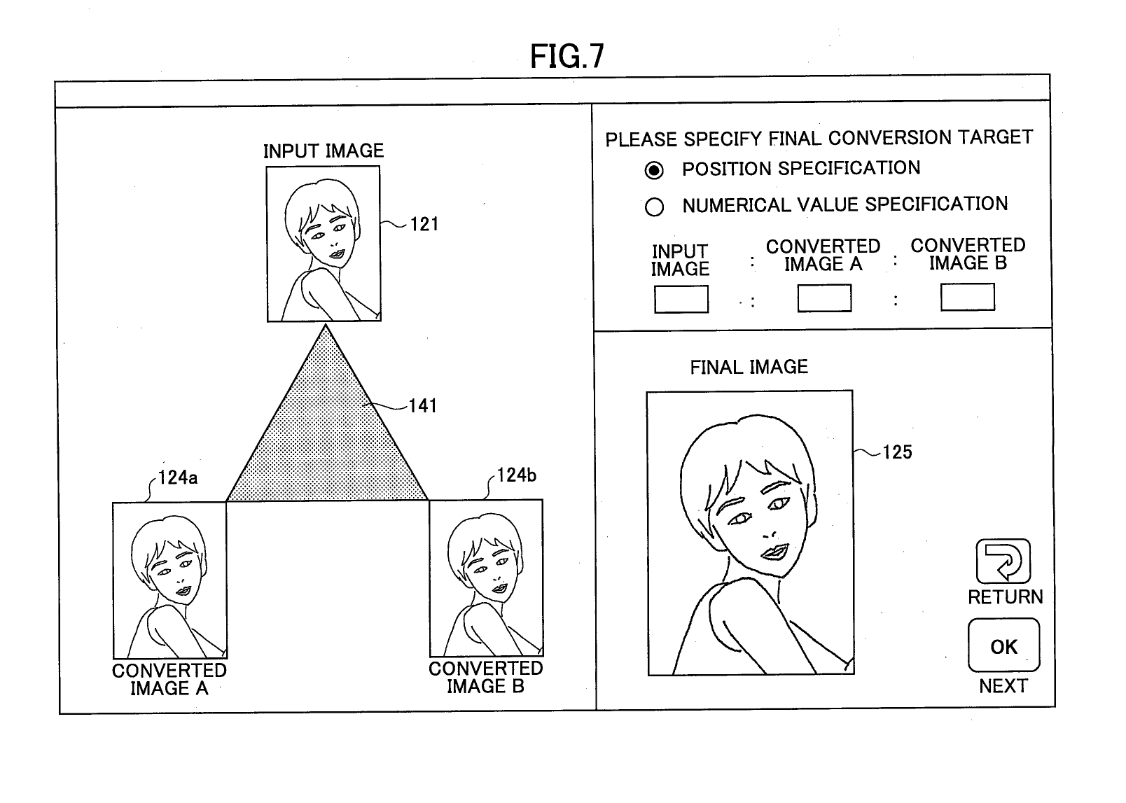

FIG. 7 is a diagram illustrating an example of the input image data 121, the converted image data “A” 124a, the converted image data “B” 124b, and the final image data 125.

As shown in FIG. 7, in the display and input unit 107, the input image data 121 is displayed in the upper left part of the screen, the converted image data “A” 124a and the converted image data “B” 124b are displayed in the lower left part. Furthermore, a final target specification region 141 surrounded by line segments, which connect two images of the above three images, is displayed simultaneously.

The final target specification region 141 is a region where the user, who executes the image processing, can specify the color tone among the input image data 121, the converted image data 124a and the converted image data 124b, as the final conversion target in the color tone conversion process for the input image data from the user. The final target specification region 141 is displayed in a line segment or a polygon, the shape of which depends on the number of the target image data selected by the user.

In the upper-right part of the screen in FIG. 7, the method of specification for the final conversion target is displayed, so as to be selectable by the user. Moreover, in the lower-right part of the screen, the final image data 125, in which the color tone is converted from that of the input image data 121 based on the input for the final conversion target, and operational buttons, such as “return”, “OK” and the like.

When the user, who executes the image processing, selects “position specification” for specifying the final conversion target, the user specifies a position in the final target specification region 141 in the display and input unit 107. The user views the input image data 121, converted image data “A” 124a and the converted image data “B” 124b, displayed on the screen, and by taking account of the relationship between the displayed images, specifies a position which is close to the desired color tone in the final target specification region 141. According to the above method, the user can specify the final target from the relative positional relationship among the input image data 121, the converted image data “A” 124a and the converted image data “B” 124b, by an intuitive and simple operation.

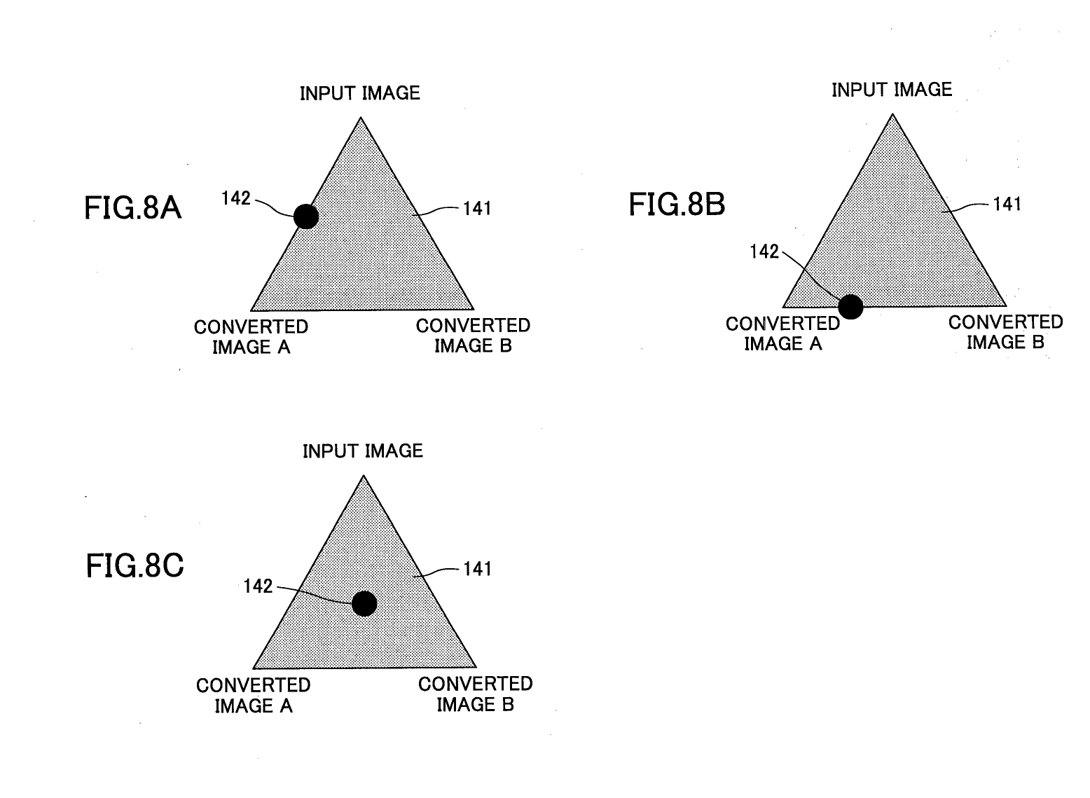

FIGS. 8A to 8C are diagrams illustrating examples of position specifications in the final target specification region 141 in the display and input unit 107. In FIGS. 8A to 8C, different positions specified as the final conversion target in the final target specification region 141 are shown. A black circle 142 in each figure indicates the position specified by the user who executes the image processing. The user specifies the position of the final conversion target, for example, through the operation of a mouse, a touch panel, or the like.

FIG. 8A illustrates an example where a midpoint between the input image data 121 and the converted image data “A” 124a is specified for the final conversion target. FIG. 8B illustrates an example where a point, which is between the converted image data “A” 124a and the converted image data “B” 124b and is close to the converted image data “A” 124a, is specified for the final conversion target. FIG. 8C is an example where a point at a center of the input image data 121, the converted image data “A” 124a and the converted image data “B” 124b is specified for the final conversion target.

On the other hand, when “numerical value specification” is selected for specifying the final conversion target, the user, who executes the image processing, inputs numerical values of ratios among the input image data 121, the converted image data “A” 124a and the converted image data “B” 124b.

For example, when the user who executes the image processing specifies by a numerical value the midpoint between the input image data 121 and the converted image data “A” 124a for the final conversion target, as in FIG. 8A, the input numerical value may be, for example, “(input image, converted image “A”, converted image “B”) is (1, 1, 0)”.

Moreover, when the user specifies by a numerical value the point, which is between the converted image data “A” 124a and the converted image data “B” 124b and is close to the converted image data “A” 124a, for the final conversion target, as in FIG. 8B, the input numerical value may be, for example, “(input image, converted image “A”, converted image “B”) is (0, 3, 1)”.

Furthermore, when the user specifies by a numerical value the point, which is the center of the input image data, the converted image data “A” 124a and the converted image data “B” 124b, for the final conversion target, as in FIG. 8C, the input numerical value may be, for example, “(input image, converted image “A”, converted image “B”) is (1, 1, 1)”.

The display and input unit 107 displays the input image data 121, the converted image data “A” 124a and the converted image data “B” 124b, and receives the user's input for the final conversion target, as described above.

<<Generate Final Conversion Information>>

When the final conversion target is input to the display and input unit 107, the final conversion unit 106 obtains final conversion information based on the input final conversion target, performs the color tone conversion for the conversion region 122 in the input image data 121 based on the final conversion information, and generates the final image data 125.

The final conversion unit 106 obtains the final conversion information according to either one of the two methods, which will be described in the following.

(First Generation Method for Generating the Final Target Information)

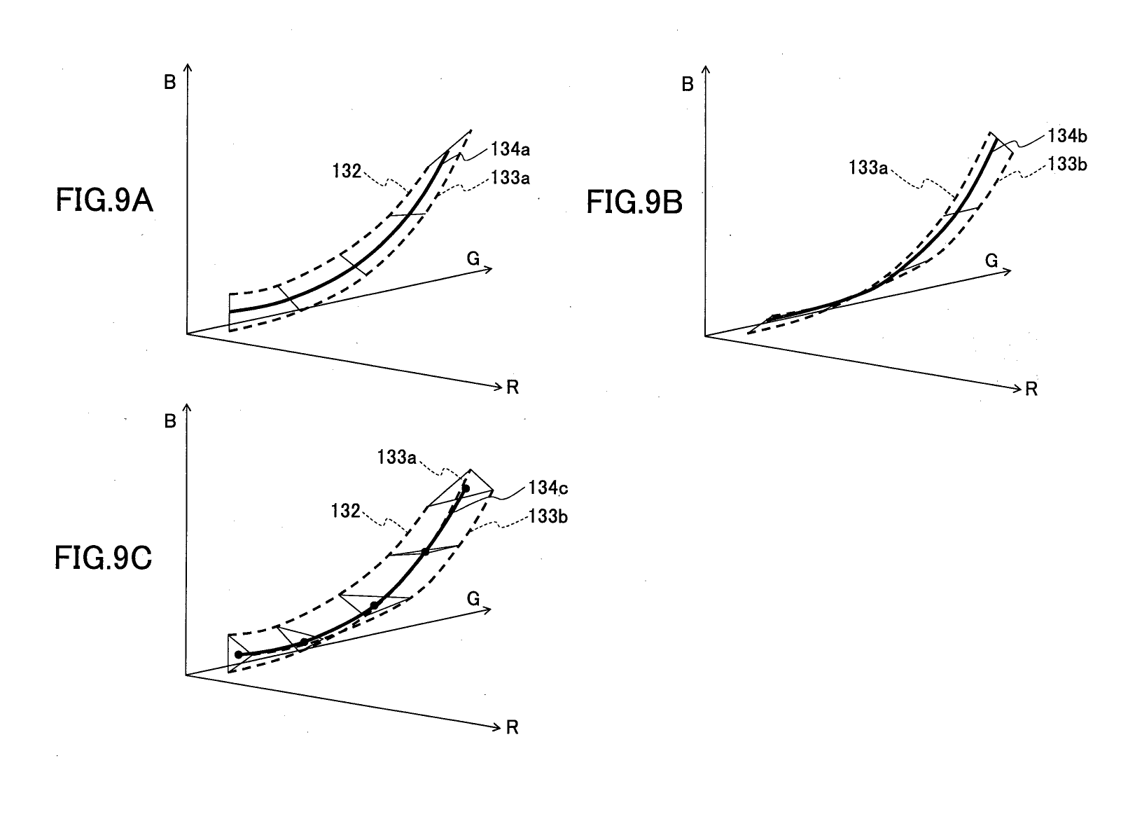

FIGS. 9A to 9C are diagrams illustrating examples of calculation of the final target color information, which is used for generating the final conversion information by the final conversion unit 106.

The final conversion unit 106, based on the final conversion target, calculates the final tone function 134 as the final target color information, from the tone function 132 of the conversion region 122 in the input image data 121 and from the target tone function 133 of the selected target image data.

FIG. 9A illustrates the example of calculation of the final tone function 134a where the midpoint between the input image data 121 and the converted image data “A” 124a is specified for the final conversion target, as shown in FIG. 8A. In this case, the final conversion unit 106 obtains the final tone function 134a, by calculating an average of the tone function 132 of the input image data 121 and the target tone function 133a of the target image data “A”, by using interpolation.

FIG. 9B illustrates the example of calculation of the final tone function 134b where the point, which is between the converted image data “A” 124a and the converted image data “B” 124b and is close to the converted image data “A” 124a, is specified for the final conversion target, as shown in FIG. 8B. Here, the ratio of the converted image data “A” 124a to the converted image data “B” 124b is assumed to be 3 to 1.

In this case, the final conversion unit 106 obtains the final tone function 134b by calculating a weighted average, multiplying the target tone function 133a of the target image data “A” by a weight coefficient of three fourths and multiplying the target tone function 133b of the target image data “B” by a weight coefficient of one fourth, by using interpolation.

FIG. 9C illustrates the example of calculation of the final tone function 134c where the center of the input image data 121, the converted image data “A” 124a and the converted image data “B” 124b is specified for the final conversion target, as shown in FIG. 8C.

In this case, the final conversion unit 106 obtains the final tone function 134c, by calculating an average of the tone function 132 of the input image data 121, the target tone function 133a of the target image data “A” and the target tone function 133b of the target image data “B”, by using the interpolation.

The final conversion unit 106 generates a final conversion table, as the final conversion information, based on the final tone function 134, as obtained above. The generated final conversion table represents the relationship between the color component value of the tone function 132 and the color component value of the final tone function 134, which is converted from the tone function 132, as the conversion table illustrated in FIGS. 6A to 6C.

The final conversion information may be, for example, not the final conversion table as above, but a conversion formula, with which the tone function 132 is converted to the final tone function 134. Moreover, the final conversion unit 106 also obtains the final tone function 134 in the same way as above for the case where the final conversion target is specified in the display and input unit 107 according to the “position specification” or the “numerical value specification”.

(Second Generation Method for Generating the Final Target Information)

Next, an other generation method for generating the final target information by the final conversion unit 106 will be described in the following.

The final conversion unit 106 obtains the final conversion table by calculating a weighted average, by multiplying the linear conversion table with which the input image data 121 is output without any conversion and the conversion table to the target image data, by the weight coefficients obtained from the final conversion target.

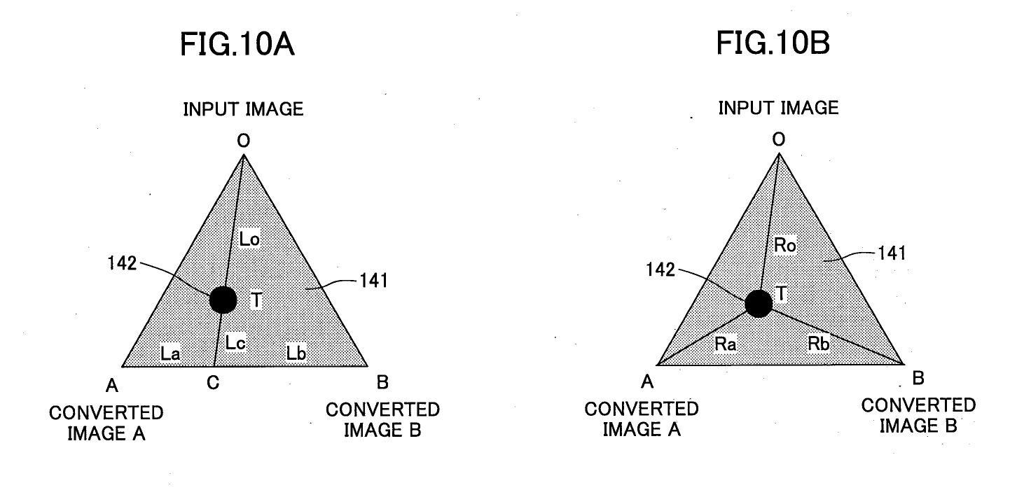

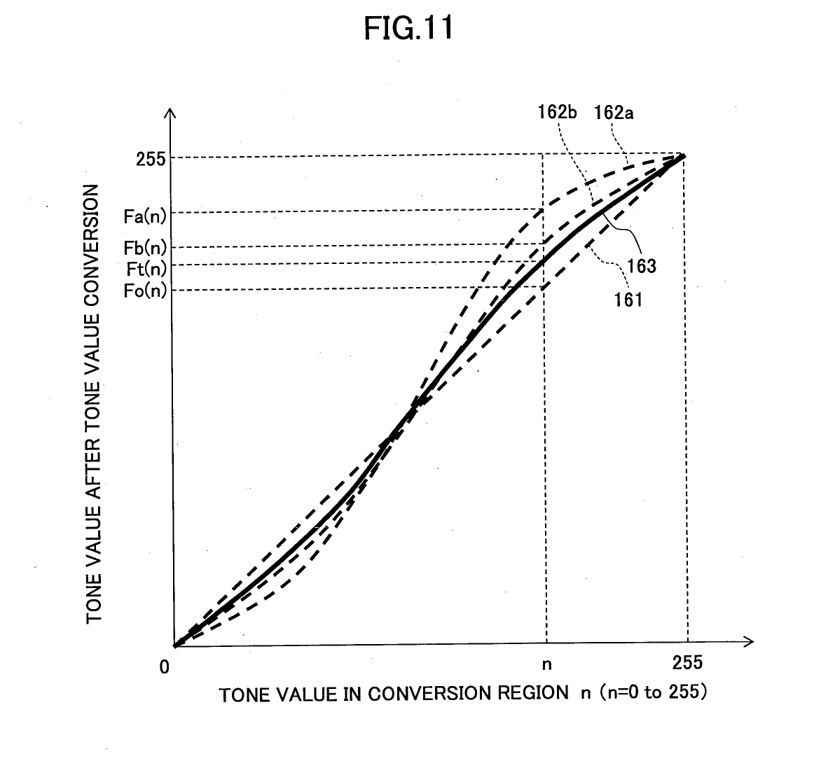

FIGS. 10A and 10B are explanatory diagrams for explaining the weight coefficients used in the generation of the final conversion information. Moreover, FIG. 11 illustrates an example of the generation of the final conversion information by the final conversion unit 106.

FIG. 10A illustrates the example where the position 142 is specified for the final conversion target in the final target specification region 141 of the display and input unit 107. Here, in the final target specification region 141, points which represent the input image data 121, the converted image data “A” 124a and the converted image data “B” 124b, are denoted “O”, “A”, and “B”, respectively. Furthermore, the specified position 142 in the final target specification region 141 is denoted “T”. Moreover, a point, at which a line through the points “O” and “T” intersects with a line through the points “A” and “B”, is denoted “C”. Lengths of the line segments OT, TC, AC and BC are denoted Lo, Lc, La and Lb, respectively.

In this case, for example, a weight coefficient ko for the input image data 121 in the weighted average is Lc/(Lo+Lc). Moreover, a weight coefficient ka for the converted image “A” 124a is (LoLb)/(Lo+Lc)/(La+Lb), and a weight coefficient kb for the converted image “B” 124b is (LoLa)/(Lo+Lc)/(La+Lb).

Moreover, FIG. 10B illustrates the example where the final conversion target is specified by inputting the numerical value to the display and input unit 107. When the numerical value input for the final conversion target is denoted “(input image data, converted image data “A”, converted image data “B”) is (Ro, Ra, Rb)”, the ratios among the lengths of the line segments in FIG. 10, i.e. (OT, AT, BT) are the same as the ratios among the numerical values (Ro, Ra, Rb).

In this case, for example, a weight coefficient ko for the input image data 121 in the weighted average is Ro/(Ro+Ra+Rb). Moreover, a weight coefficient ka for the converted image “A” 124a is Ra/(Ro+Ra+Rb), and a weight, coefficient kb for the converted image “B” 124b is Rb/(Ro+Ra+Rb).

In the example of the generation of the final conversion information, as shown in FIG. 11, for a tone value “n” in the conversion region 122, the tone value converted by the linear conversion table 161, the tone value converted by the conversion table 162a of the converted image data “A”, and the tone value converted by the conversion table 162b of the converted image data “B”, are denoted Fo(n), Fa(n) and Fb(n), respectively.

The final conversion unit 106 obtains final conversion information by calculating a final conversion table Ft(n) 163, with which the color tone conversion is performed for the conversion region 122 in the input image data 121, according to the following formula (1):

Ft(n)=ko·Fo(n)+ka·Fa(n)+kb·Fb(n) Formula (1)

The final conversion unit 106 calculates the final conversion table for all the color components (for the RGB color system, the R, G and B color components), according to formula (1), as the final conversion information, which converts the conversion region 122.

The method of calculating the weight coefficient is not limited to the above description. The weight coefficient may be arbitrarily set according to the specified position in the final target specification region 141 input to the display and input unit 107 or according to the input numerical value for specification.

Moreover, the final conversion unit 106, in the operation described in the section of (First generation method for generating the final target information), by using the above weight coefficients, may calculate a weighted average of the tone function 132 and the target tone function 133, as the final tone function, and generate the conversion table based on the calculated final tone function.

<<Generate Final Image Data>>

The final conversion unit 106 calculates the final conversion table as the final conversion information, and performs the color tone conversion for the conversion region in the input image data 121 based on the final conversion table, to generate the final image data.

Since the final conversion unit 106 performs the color tone conversion for the conversion region 122 based on the final conversion table, the color tone of the conversion region 122 can be adjusted to the color tone desired by the user who executes the image processing. The final conversion unit 106 may perform the color tone conversion for a region other than the conversion region 122 in the input image data 121, in the same way as for the conversion region 122.

The final image data 125, the color tone of which has been converted by the final conversion unit 106, is displayed on the display and input unit 107, as shown in FIG. 7 for example. The user who executes the image processing can verify the result of the image processing.

<Flow of Image Processing>

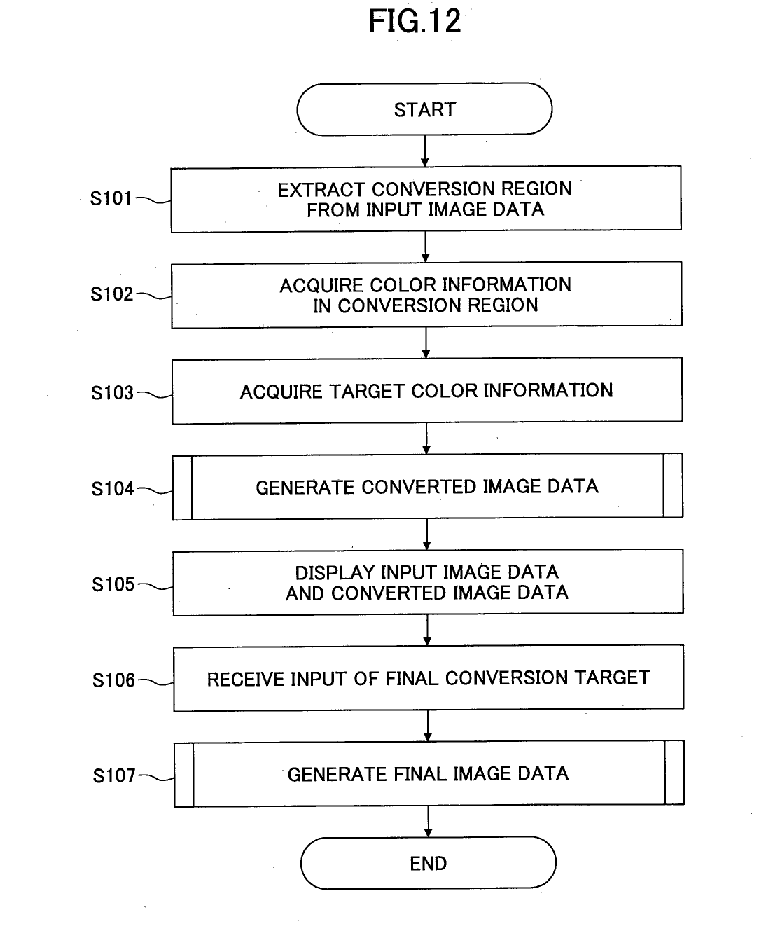

FIG. 12 is a flowchart illustrating an example of the image processing in the image processing apparatus according to the first embodiment.

When image data is input to the image processing apparatus 100, the region extraction unit 101 extracts a conversion region 122, in which color information is converted, from the input image data 121 (step S101). Next, the conversion unit 105 acquires a tone function 132 as the color information of the conversion region 122 (step S102).

Next, when the user, who executes the image processing, selects a target image data from a group of target image data 123 displayed on the display and input unit 107, the target color information acquisition unit 103 acquires a target tone function 133 corresponding to the target image data from a storage unit 104 (step S103).

The conversion unit 105 executes a conversion image data generation process, to generate a converted image data 124 from the input image data (step S104).

When the converted image data 124 is generated, the display and input unit 107 displays the input image data 121 and the converted image data 124 (step S105), and receives an input for a final conversion target (step S106).

When the final conversion target is input, the final conversion unit 106 executes a final image data generation process, to generate a final image data 125 (step S107). Then, the process ends.

(Conversion Image Data Generation Process)

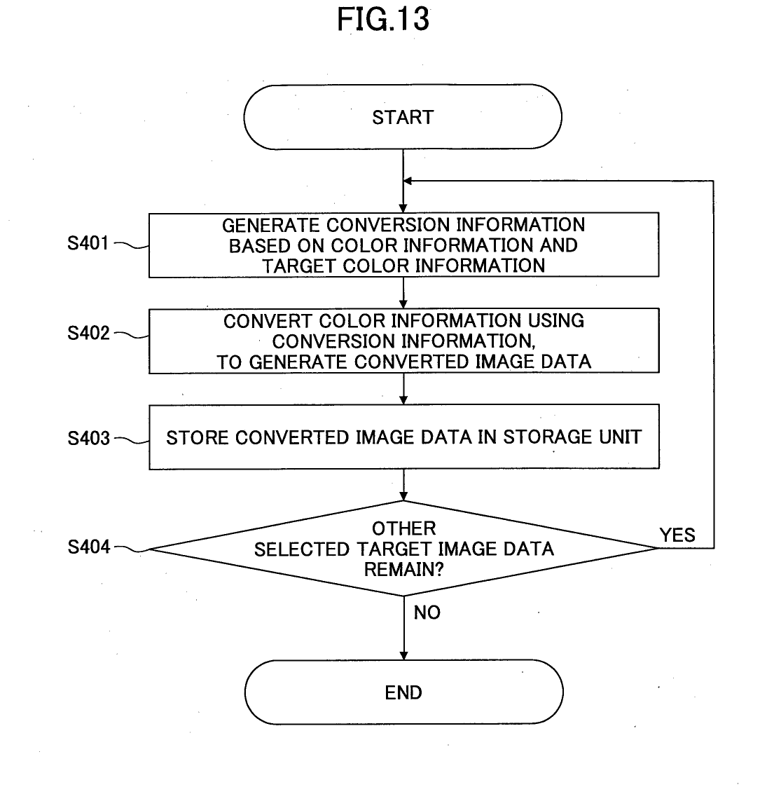

FIG. 13 is a flowchart illustrating the process of the conversion image data generation process, in which the conversion unit 105 converts the conversion region 122 in the input image data 121 and generates the converted image data 124.

The conversion unit 105 generates, as conversion information, a conversion table from a tone function 132 of the conversion region 122 and from a target tone function 133 of the target image data (step S401).

Next, the conversion unit 105, based on the conversion table, executes the color tone conversion for the conversion region 122 in the input image data 121 (step S402), generates a converted image data 124, and stores the generated converted image data 124 in a storage unit 104 (step S403).

The conversion unit 105 determines whether the target image data selected by the user, who executes the image processing, includes target image data which has not generated converted image data (step S404). The conversion unit 105 repeatedly executes the processes of steps S401 to S403, until converted image data 124 corresponding to all the target image data selected by the user are generated.

The conversion unit 105, according to the process as explained above, for each of the target image data selected by the user, who executes the image processing, generates conversion image data 124 corresponding to the target image data.

(First Generation Method of Generating Final Image Data)

Next, the final image data generation process by the final conversion unit 106 will be explained.

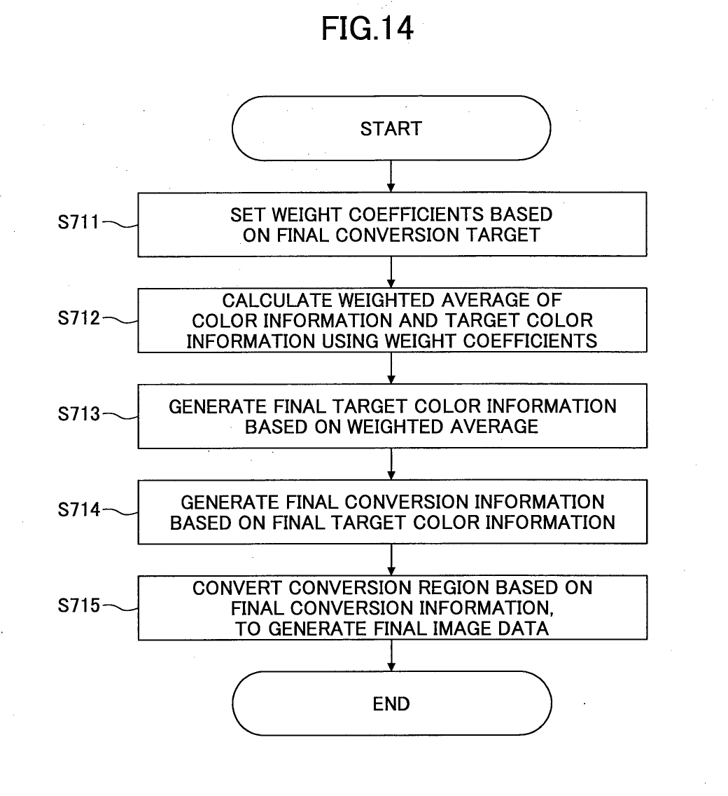

FIG. 14 is a flowchart illustrating an example of a process of generating a final image, in which the final conversion unit 106 converts the conversion region 122 of the input image data 121, and generates the final image data 125. FIG. 14, as explained in the section of (First generation method for generating the final target information), illustrates an example of a process that the final conversion unit 106 calculates the final tone function using a weight coefficient and generates the final image data 125 based on the final conversion table obtained from the final tone function.

The final conversion unit 106, sets a weight coefficient corresponding to the input image data and to the target image data, according to the final conversion target, input to the display and input unit 107 (step S711).

Next, the final conversion unit 106 calculates a weighted average of a tone function 132 of the conversion region 122 in the input image data 121 and a target tone function 133 of the target image data using the weight coefficients (step S712). The final conversion unit 106 generates a final tone function from the weighted average value (step S713).

The final conversion unit generates a final conversion table as the final conversion information from the final tone function (step S714). Next, the final conversion unit converts the conversion region 122 in the input image data 121 based on the final conversion table, and generates a final image data 125. Then, the process ends.

(Second Generation Method of Generating Final Image Data)

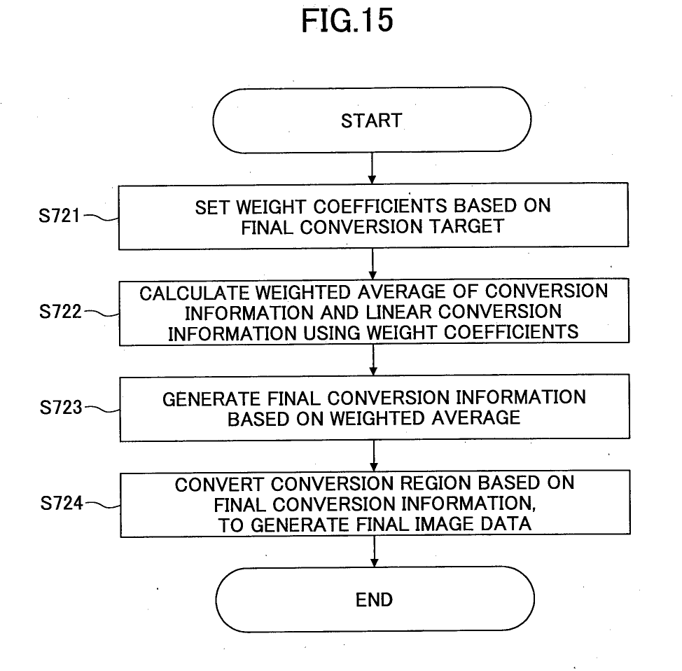

FIG. 15 is a flowchart illustrating an example of the final image data generation process, in which the final conversion unit 106 converts the conversion region 122 in the input image data 121 and generates the final image data 125. FIG. 15 is, as explained in the section of (Second generation method of generating final conversion information), illustrates the process, in which the final conversion unit 106 obtains the final conversion table 163 from the conversion table and from the linear conversion table, using the weight coefficients, and generates the final image data 125 based on the final generation table 163.

The final conversion unit 106 sets the weight coefficients for the input image data and for the target image data based on the final conversion target input to the display and input unit 107 (step S721).

Next, the final conversion unit 106, by using the weight coefficients, calculates a weighted average of a linear conversion table, with which the input image data 121 is output without any conversion, and the conversion table to the target image data (step S722). Next, the final conversion unit 106 generates the final conversion data as the final conversion information from the calculated weighted average (step S723).

Finally, the final conversion unit 106 converts the color tone of the conversion region 122 in the input image data 121 based on the final conversion data, and generates the final image data 125. Then, the process ends.

As described above, according to the image processing apparatus 100 according to the first embodiment, the user, who executes the image processing, can easily obtain a final image data 125 from the input image data 121, in which a color tone of a conversion region 122 is converted into the desired color tone. The user who executes the image processing can convert the color tone of the conversion region not only into the color tone of the prepared target image data in advance but also into an intermediate color tone between the conversion region and the target image data. The operation by the user, who executes image processing, is only selecting the target image data having a desired color tone and specifying the final conversion target by touching a desired position on a screen or inputting a numerical value. The above operation does not require deep knowledge or considerable experience in image processing, and the user can obtain a subjectively desirable image by an intuitive and simple operation.

The image processing apparatus 100 according to the first embodiment, as explained above, may be applied to various apparatuses which execute processes for image data, such as a complex copy machine, a printer, a facsimile machine, a scanner machine, a digital camera, or a personal computer (PC), by adding necessary functions.

Moreover, the functions, with which the image processing apparatus 1000 according to the first embodiment is equipped with, can be realized by executing in a computer the operating procedures, explained above, as a computer program, in which the operating procedures are coded in a programming language used in the image processing apparatus 1000. Accordingly, the program, which realizes the image processing apparatus 1000, can be stored in a recording medium 1108, readable by the computer.

Accordingly, the program according to the first embodiment, which can be stored in the recording medium 1108, such as a floppy disk®, a CD (Compact Disc), or a DVD (Digital Versatile Disk), can be installed in the image processing apparatus 1000 from the recording medium 1108. Moreover, since the image processing apparatus 1000 includes the network I/F unit 1105, the program according to the first embodiment can be downloaded via a communication line, such as the Internet, and installed.

### Second Embodiment

Next, the image processing system according to the second embodiment will be described with reference to the accompanying drawings. Meanwhile, the same reference numerals are assigned to the members which have substantially the same functions or configuration as the image processing apparatus 1000 according to the first embodiment. The duplicate explanations will be omitted.

Moreover, in the following embodiment, as an image input apparatus receiving an input of image data, a complex machine having a print function, a scanner function, a copy function or a facsimile function in a chassis, is exemplified. The present embodiment is not limited to this. For the image input apparatus, as long as image data can be input, any of a scanner machine, a facsimile machine or a copy machine may be used.

<Configuration of Image Processing System>

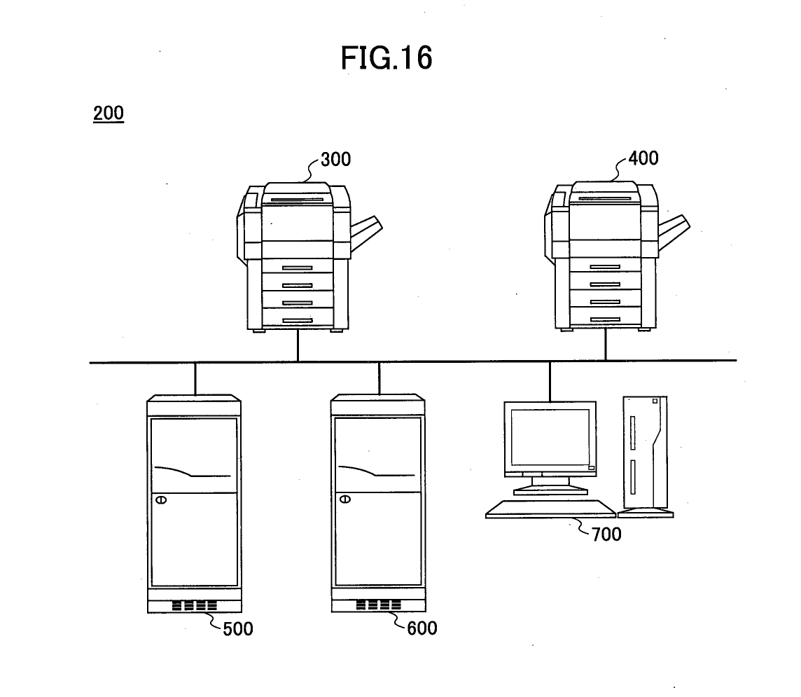

FIG. 16 is a diagram illustrating an example of a configuration of the image processing system according to the second embodiment. As shown in FIG. 16, the image processing system 200 includes MFPs (Multifunction Peripherals) 300, 400, image processing servers 500, 600 as the image processing apparatuses, and an information processing terminal 700 such as a PC (Personal Computer). The above components are connected via a network.

In the image processing system 200 according to the second embodiment, the numbers of the MFPs, the image processing servers, and the information processing terminals are not limited and may be arbitrary numbers. In the following, the MFP 300 and the image processing server 500 will be explained. A explanation for the MFP 400 and the image processing server 600, which have the same configurations as the MFP 300 and the image processing server 600 respectively, will be omitted.

The MFP 300 is a complex machine, which has a scanner function for reading out an image, a copy function, a printer function, a facsimile function and the like in a chassis. The MFP 300 scans a paper medium or the like by using the scanner function, generates image data, and transmits the generated image data to the image processing server 500. Details of the MFP 300 will be described later.

The image processing server 500 is an image processing apparatus, which performs image processing for an image read out by the MFP 300, 400 or image data acquired via a network. The information processing terminal 700 may be equipped with the function of image processing, which the image processing server 500 has.

<Hardware Configuration of MFP>

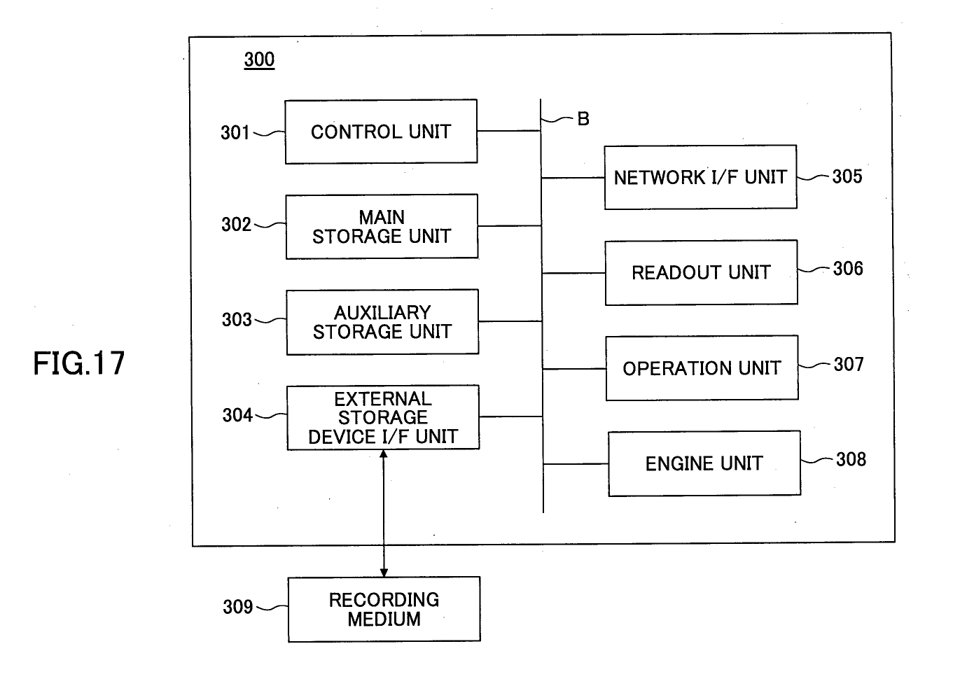

FIG. 17 is a diagram illustrating an example of a hardware configuration of the MFP 300.

As shown in FIG. 17, the MFP 300 includes a control unit 301, a main storage unit 302, an auxiliary storage unit 33, an external storage device I/F unit 304, a network I/F unit 305, a readout unit 306, an operation unit 307, and an engine unit 308.

The control unit 301 is a CPU, which controls each unit in the apparatus, and computes or processes data. Moreover, the control unit 301 is a processing unit that executes a program stored in the main storage unit 302. The control unit 301 receives data from an input device or a storage device, calculates or processes the data, and outputs the data to an output device or the storage device.

The main storage unit 302 is a ROM (Read-Only Memory), a RAM (Random Access Memory), or the like. The main storage unit 302 stores or temporarily saves a program, such as an OS as a basic system or an application software executed at the control unit 301, or data.

The auxiliary storage unit 303 is a HDD or the like. The auxiliary storage unit 303 stores data related to the application software or the like.

The external storage device I/F unit 304 is an interface between a recording medium 309, such as a flash memory, connected via a data transmission path, such as a USB (Universal Serial Bus) and the MFP 300.

Moreover, the program stored in the recording medium 309 is installed via the external storage device I/F unit 304, and becomes executable by the MFP 300.

The network I/F unit 305 is an interface between a peripheral device having a communication device connected via a network such as a LAN (Local Area Network) or a WAN (Wide Area Network), which are configured by a data communication path of a wireless and/or wired line and the MFP 300.

The readout unit 306 is a scanner device, which scans a paper medium, to read out an image, and acquires image data from the image.

The operation unit 307 includes a key switch (hardware key) and an LCD (Liquid Crystal Display), equipped with a touch panel function (including a software key in a GUI (Graphical User Interface)). The operation unit 307 is a display device and/or an input device, i.e. the operation unit 307 functions as a UI (User Interface) for using the functions, with which the MFP 300 is equipped.

The engine unit 308 is a mechanical part, such as a plotter, which performs a process of forming an image on a paper medium or the like.

<Hardware Configuration of Image Processing Server>

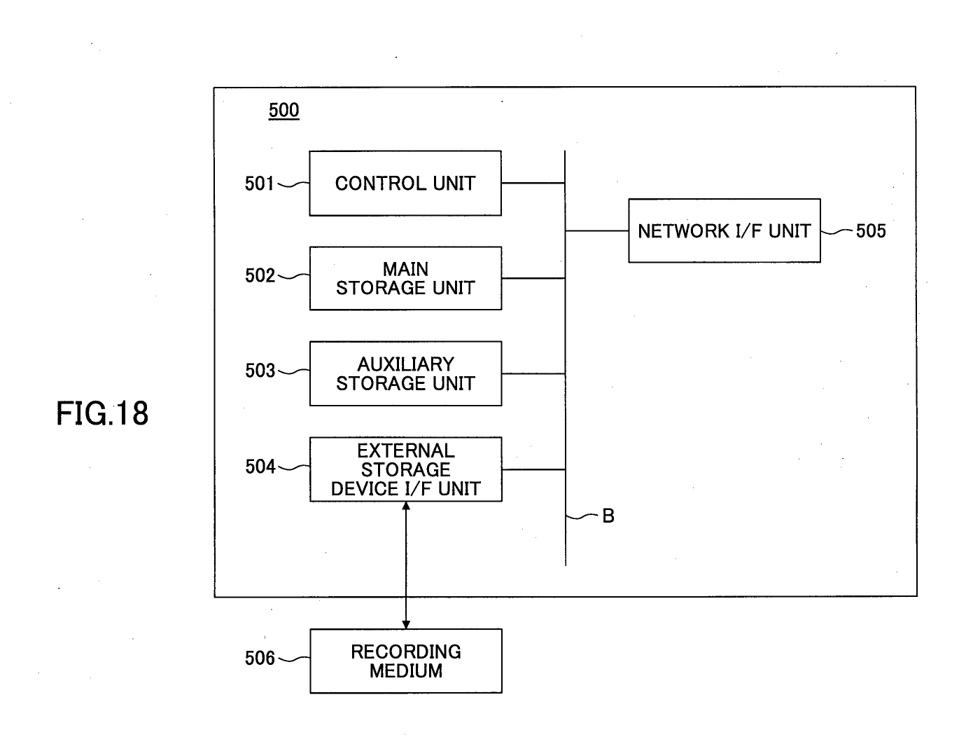

FIG. 18 is a diagram illustrating an example of a hardware configuration of the image processing server 500.

As shown in FIG. 18, the image processing server 500 includes a control unit 501, a main storage unit 502, an auxiliary storage unit 503, an external storage device I/F unit 504 and a network I/F unit 505.

The control unit 501 is a CPU, which controls each unit in the apparatus, and computes or processes data. Moreover, the control unit 501 is a processing unit that executes a program stored in the main storage unit 502. The control unit 501 receives data from an input device or a storage device, calculates or processes the data, and outputs the data to an output device or the storage device.

The main storage unit 502 is a ROM (Read-Only Memory), a RAM (Random Access Memory), or the like. The main storage unit 502 stores or temporarily saves a program, such as an OS as a basic system or an application software executed at the control unit 501, or data.

The auxiliary storage unit 503 is a HDD or the like. The auxiliary storage unit 503 stores data related to the application software or the like.

The external storage device I/F unit 504 is an interface between a recording medium 506, such as a flash memory, connected via a data transmission path, such as a USB (Universal Serial Bus) and the image processing server 500.

Moreover, the program stored in the recording medium 506 is installed via the external storage device I/F unit 504, and becomes executable by the image processing server 500.

The network I/F unit 505 is an interface between a peripheral device having a communication device connected via a network such as a LAN (Local Area Network) or a WAN (Wide Area Network), which are configured by a data communication path of a wireless and/or wired line and the image processing server 500. Moreover, the image processing server may include an operation unit having a keyboard or the like, and a display unit having an LCD or the like, though the operation unit and the display unit are not shown in FIG. 18.

A hardware configuration of the information processing terminal 700 is the same as the image processing apparatus according to the first embodiment, as shown in FIG. 1.

<Functional Configuration of Image Processing System>

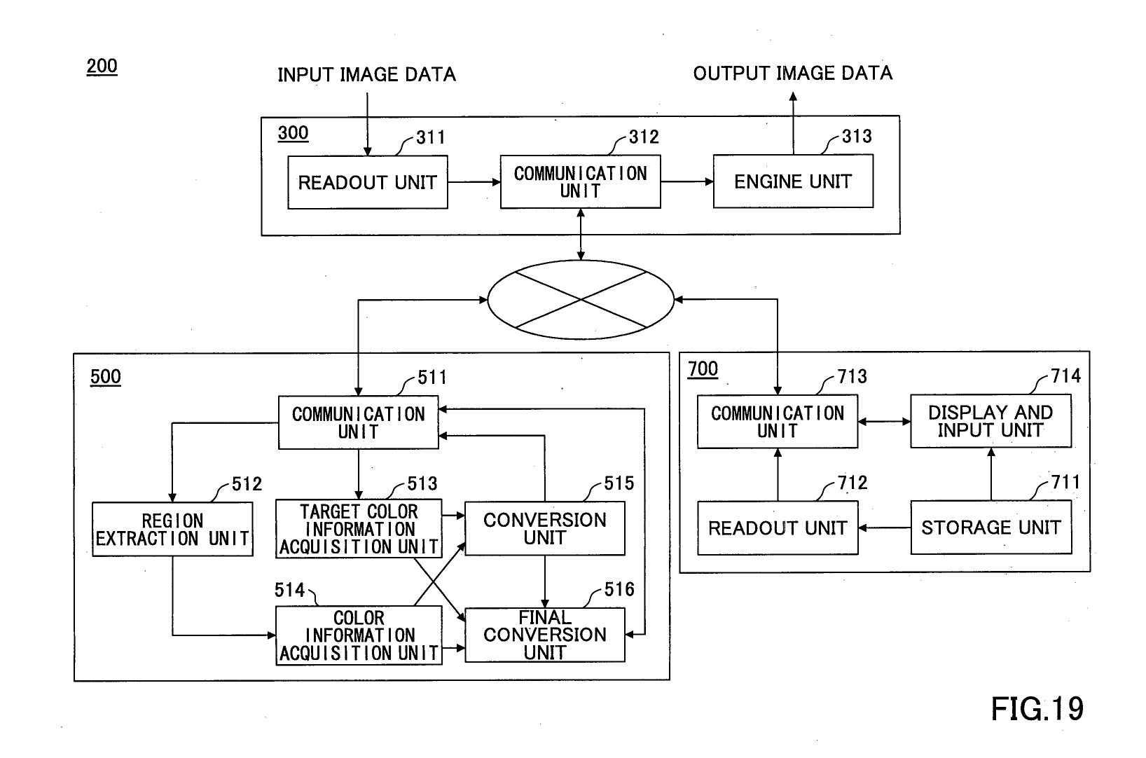

FIG. 19 is a diagram illustrating an example of a functional configuration of the image processing system 200 according to the second embodiment.

As shown in FIG. 19, the MFP 300 includes the readout unit 311, a communication unit 312 and an engine unit 313.

The readout unit 311 can acquire image data, for which an image processing is performed, by scanning a paper medium.

The communication unit 312 can receive image data stored in a storage unit 711 of the information processing terminal 700. Moreover, the communication unit 312 can transmit the image data acquired by the readout unit 311 to the image processing server as an image processing apparatus, and can receive the image data, for which the image processing server 500 performs the image processing.

The engine unit 313 can print the image data, for which the image processing server 500 performed the image processing, on a recording medium, such as a paper medium, and thereby output the image data. Moreover, the engine unit can print the image data, for which the image processing server 500 performed an image conversion, on a recording medium, and output the image data.

The information processing terminal 700 includes a storage unit 711, a readout unit 712, a communication unit 713 and a display and input unit 714.

The storage unit 711 stores image data group 123 to be selected as a target, and plural target tone functions 133 as target color information corresponding to the image data group 123.

The readout unit 712 reads out the target image data group 123 and a target tone function 133 corresponding to target image data selected by the user who executes the image processing from the storage unit 711.

The communication unit 713 transmits the target image data group 123 and the target tone function 133 read out by the readout unit from the storage unit 711 to the MFP or the information processing server 500. Moreover, the communication unit receives input image data 121, final image data 125, or the like, transmitted from the MFP 500 or from the image processing server 500.

On the display and input unit 714, the input image data 121 and the final image data 125, received by the communication unit 713, the target image data group 123 stored in the storage unit 711, or the like, are displayed.

Meanwhile, either the MFP 300 or the image processing server 500 may be provided with at least one of the functions, with which the information processing terminal 700 is equipped.

The image processing server 500 includes a communication unit 511, a region extraction unit 512, a target color information acquisition unit 513, a color information acquisition unit 514, a conversion unit 515, and a final conversion unit 516. A function of each unit is the same as the function of the corresponding unit in the image processing apparatus 100 according to the first embodiment. Meanwhile, either the MFP 300 or the information processing terminal 700 may be equipped with at least one of the functions, with which the information processing server 500 is equipped.

In the image processing system according to the second embodiment, the user, who executes the image processing, acquires an image including a conversion region for which the image processing is performed, as image data by the readout unit 311, and further acquires final image data 125 for which the image conversion processing was performed by the image processing server 500. The user, who executes the image processing, may read out image data including the conversion region for which the image processing is performed, from the information processing terminal 700, and may perform the image conversion processing for the image data by the image processing server 500.

In the image processing server 500, the region extraction unit 512 extracts the conversion region 122, and the color information acquisition unit 514 acquires a tone function, as color information for the conversion region 122. Moreover, the target color information acquisition unit 513 acquires a target tone function, as target color information acquired from the information processing terminal 700 via the communication unit 511. The conversion unit 515 generates converted image data 124 based on the target tone function, and transmits the converted image data 124 to the information processing terminal 700 via the communication unit 511.

In the information processing terminal 700, on the display and input unit 714 the input image data 121 and the converted image data 124 are displayed. The user, who executes the image processing, inputs a final conversion target. The final conversion target is transmitted to the image processing server 500 by the communication unit 713.

In the image processing server 500, the final conversion unit 516 obtains a final conversion table based on the final conversion target, and generates the final image data 125 based on, the final conversion table. The final image data 125 are transmitted to the information processing terminal 700 by the communication unit 511 and are displayed on the display and input unit 714. The final image data 125 may be transmitted to the MFP 300, and are printed on a recording paper by the engine unit 313. According to the above operations, the user, who executed the image processing, can obtain an image output having the desired color tone.

As described above, in the image processing system 200 according to the second embodiment, the user, who executes the image processing, can perform a color tone conversion process, from the information processing terminal 700 with a simple operation, for the conversion region 122 in the input image data 121, acquired by the MFP 300 or the like, and obtain the final image data.

The image processing apparatus, the image processing system, the image processing method, the program thereof and a recording medium storing the program according to the embodiments are described as above. The present invention is not limited to these embodiments, but various variations and modifications may be made without departing from the scope of the present invention.

The present application is based on and claims the benefit of priority of Japanese Priority Application No. 2013-042608 filed on Mar. 5, 2013, with the Japanese Patent Office, the entire contents of which are hereby incorporated by reference.

### DESCRIPTION OF THE REFERENCE NUMERALS

100, 1000 image processing apparatus

101, 512 region extraction unit

102, 514 color information acquisition unit

103, 513 target color information acquisition unit

104, 711 storage unit

105, 515 conversion unit

106, 516 final conversion unit

107, 714 display and input unit

121 input image data

122 conversion region

123 target image data group

124a converted image data “A”

124b converted image data “B”

125 final image data

131 color component

132 tone function

133, 133a, 133b target tone function

141 final target specification region

142 specified position

134a, 134b, 134c final tone function

161 linear conversion table

162a conversion table of converted image data “A”

162b conversion table of converted image data “B”

163 final conversion table

200 image processing system

300, 400 MFP

301, 501, 1101 control unit

302, 502, 1102 main storage unit

303, 503, 1103 auxiliary storage unit

304, 504, 1104 external storage device I/F unit

305, 505, 1105 network I/F unit

306, 311, 712 readout unit

307, 1107 operation unit

308, 313 engine unit

309, 506, 1108 recording medium

312, 511, 713 communication unit

500, 600 image processing server

700 information processing terminal

1106 display unit

1-8. (canceled)

9. An image processing apparatus comprising:
a region extraction unit configured to extract a conversion region of human skin from input image data;
a color information acquisition unit configured to acquire color information from the conversion region;
a target color information acquisition unit configured to acquire target color information, which is a target of conversion for the color information;
a conversion unit configured to generate conversion information based on the color information and the target color information, and to convert the color information based on the conversion information, to generate converted image data;
a display and input unit configured to display the input image data and the converted image data, and to receive an input of a final conversion target, which is a final target of conversion for the color information; and
a final conversion unit configured to generate final conversion information based on the final conversion target, and to convert the color information based on the final conversion information, to generate final image data.

10. The image processing apparatus, as claimed in claim 9, wherein
the display and input unit displays a line segment or a polygon, which connects a point representing the input image data and a point representing the converted image data, and receives an input of a target position on the line segment or the polygon as the final conversion target, and
the final conversion unit generates the final conversion information using weight coefficients, which are derived from a positional relationship among the points and the target position.

11. The image processing apparatus, as claimed in claim 9, wherein
the display and input unit receives an input of a ratio between the input image data and the converted image data as the final conversion target, and
the final conversion unit generates the final conversion information using weight coefficients, which are derived from the ratio.

12. The image processing apparatus, as claimed in claim 10, wherein
the final conversion unit calculates a weighted average of the color information and the target color information using the weight coefficients, to obtain final target color information, and generates the final conversion information based on the final target color information.

13. The image processing apparatus, as claimed in claim 10, wherein
the final conversion unit calculates a weighted average of the conversion information and linear conversion information using the weight coefficients, to generate the final conversion information, the linear conversion information being generated without converting the color information.

14. The image processing apparatus, as claimed in claim 9, wherein
the final conversion unit converts color information in a region other than the conversion region in the input image data based on the final conversion information, to generate final image data.

15. An image processing system comprising an image processing apparatus and an information processing terminal, which are connected with each other via a network, wherein
the image processing apparatus includes:
a region extraction unit configured to extract a conversion region of human skin from input image data;
a color information acquisition unit configured to acquire color information from the conversion region;
a target color information acquisition unit configured to acquire target color information, which is a target of conversion for the color information;
a conversion unit configured to generate conversion information based on the color information and the target color information, and to convert the color information based on the conversion information, to generate converted image data; and
a final conversion unit configured to generate final conversion information based on an input final conversion target, which is a final target of conversion for the color information, and to convert the color information based on the final conversion information, to generate final image data, and
the information processing terminal includes a display and input unit configured to display the input image data and the converted image data, and to receive an input of the final conversion target.

16. An image processing method comprising:
extracting a conversion region of human skin from input image data;
acquiring color information from the conversion region;
acquiring target color information, which is a target of conversion for the color information;
generating conversion information based on the color information and the target color information, and converting the color information based on the conversion information, to generate converted image data;
displaying the input image data and the converted image data, and receiving an input of a final conversion target, which is a final target of conversion for the color information; and
generating final conversion information based on the final conversion target, and converting the color information based on the final conversion information, to generate final image data.
